(19) United States
(12) Patent Application Publication
(10) Pub. No.: US 2026/0301311 A1
(43) Pub. Date: Oct. 1, 2026

(54) IMAGE PROCESSING SYSTEM, IMAGE PROCESSING METHOD, AND INFORMATION STORAGE MEDIUM

(71) Applicants: Sony Interactive Entertainment Inc., Tokyo (JP); Sony Group Corporation, Tokyo (JP)

(72) Inventors: Takashi Amada, Tokyo (JP); Takuro Kawai, Tokyo (JP)

(73) Assignees: Sony Interactive Entertainment Inc., Tokyo (JP); Sony Group Corporation, Tokyo (JP)

(21) Appl. No.: 19/565,968

(22) Filed: Mar. 13, 2026

Related U.S. Application Data
(60) Provisional application No. 63/779,288, filed on Mar. 28, 2025.

(51) Int. Cl. G06T 15/20; G06T 7/246; G06T 7/55; G06T 7/73

(52) U.S. Cl. CPC G06T 15/205; G06T 7/248; G06T 7/55; G06T 7/74; G06T 2200/04

(57) ABSTRACT

An image processing system identifies an appearing pixel among pixels of an n-th input frame and in an area in which a whole or part of an object that had not been displayed in an (n-1)-th input frame is displayed, acquires (n-1)-th auxiliary information by replacing a pixel value of the appearing pixel in (n-1)-th feature information with a predetermined value, acquires an (n-1)-th amount of motion indicating magnitude of motion in each pixel of the (n-1)-th input frame and an n-th amount of motion indicating magnitude of motion in each pixel of the n-th input frame, and, when the (n-1)-th amount of motion in a predetermined pixel in the (n-1)-th input frame is less than a first threshold and the n-th amount of motion in the predetermined pixel in the n-th input frame is less than a second threshold, does not identify the predetermined pixel as the appearing pixel.

### CROSS-REFERENCES TO RELATED APPLICATIONS

This application claims the benefit of priority to U.S. Provisional Patent Application No. 63/779,288, filed Mar. 28, 2025, the contents of which is incorporated herein by reference in its entirety for all purposes.

### TECHNICAL FIELD

The present invention relates to an image processing system, an image processing method, and an information storage medium.

### BACKGROUND ART

A technology (super resolution) of estimating a high quality image in reference to a low quality image with use of a machine learning model has hitherto been known (see Non Patent Document 1 described below).

### NON PATENT DOCUMENT

Chao Dong, Chen Change Loy, Kaiming He, Xiaoou Tang. Learning a Deep Convolutional Network for Image Super-Resolution, in Proceedings of European Conference on Computer Vision (ECCV), 2014

### SUMMARY OF THE INVENTION

### PROBLEM TO BE SOLVED BY THE INVENTION

Embodiments of the present disclosure describe techniques for using a machine learning model having a recursive configuration that uses information regarding past frames, in order to realize super resolution for moving images as exemplified by a game screen. In the present technology, in order to suppress the occurrence of what is generally called a ghost phenomenon, it is preferable to perform processing of identifying an appearing pixel in an area in which a whole or part of an object that had not been displayed in the past frame is displayed, and not using information regarding the appearing pixel as the information regarding past frames. However, in the case of performing such processing, if an appearing pixel is identified unnecessarily, information regarding past frames which should be used under ordinary circumstances may not be used appropriately. In particular, if an appearing pixel is continuously identified due to slight motion such as jitter and an area in which information regarding past hurray is not available at all times is generated, the estimation accuracy in the machine learning model may decline.

The present invention has an object of providing an image processing system, an image processing method, and an information storage medium that can restrain the estimation accuracy in the machine learning model from declining.

### MEANS FOR SOLVING THE PROBLEM

An image processing system according to the present invention is an image processing system that acquires first through N-th (n is a natural number equal to or greater than two) input frames by rendering three dimensional data that indicates one or more objects and in which a virtual space is viewed from a predetermined viewpoint, and acquires an n-th (n = 2, 3, ..., N) estimated frame that is to be output from a machine learning model as a result of an n-th input frame and (n-1)-th auxiliary information being input to the machine learning model, the (n-1)-th auxiliary information being based on (n-1)-th feature information indicating a feature of an (n-1)-th input frame, the image processing system including at least one processor, in which the at least one processor acquires (n-1)-th depth information indicating a depth of each pixel of the (n-1)-th input frame and n-th depth information indicating a depth of each pixel of the n-th input frame, identifies an appearing pixel that is among pixels of the n-th input frame and is in an area in which a whole or part of the object that had not been displayed in the (n-1)-th input frame is displayed, in reference to the (n-1)-th depth information and the n-th depth information, acquires the (n-1)-th auxiliary information by replacing a pixel value of the appearing pixel in the (n-1)-th feature information with a predetermined value, acquires an (n-1)-th amount of motion indicating magnitude of motion in each pixel of the (n-1)-th input frame and an n-th amount of motion indicating magnitude of motion in each pixel of the n-th input frame, and, when the (n-1)-th amount of motion in a predetermined pixel in the (n-1)-th input frame is less than a first threshold and the n-th amount of motion in the predetermined pixel in the n-th input frame is less than a second threshold, does not identify the predetermined pixel as the appearing pixel.

### BRIEF DESCRIPTION OF THE DRAWINGS

FIG. 1 is a diagram illustrating an example of a hardware configuration of an image processing system.

FIG. 2 is a diagram illustrating an outline of the image processing system.

FIG. 3 is a functional block diagram illustrating an example of functions implemented by the image processing system.

FIG. 4 is a diagram describing processing in a rendering section.

FIG. 5 is a diagram describing processing in an input frame acquiring section.

FIG. 6 is a diagram illustrating an example of generation of a disocclusion mask.

FIG. 7 is a diagram illustrating an example of a case of suppressing generation of a disocclusion mask.

FIG. 8A is a flowchart illustrating an example of a flow of processing executed in the image processing system.

FIG. 8B is a flowchart illustrating an example of a flow of processing executed in the image processing system.

### MODE FOR CARRYING OUT THE INVENTION

One example of an image processing system according to an embodiment of the present invention is hereinafter described with reference to the drawings.

### 1. Hardware configuration of image processing system

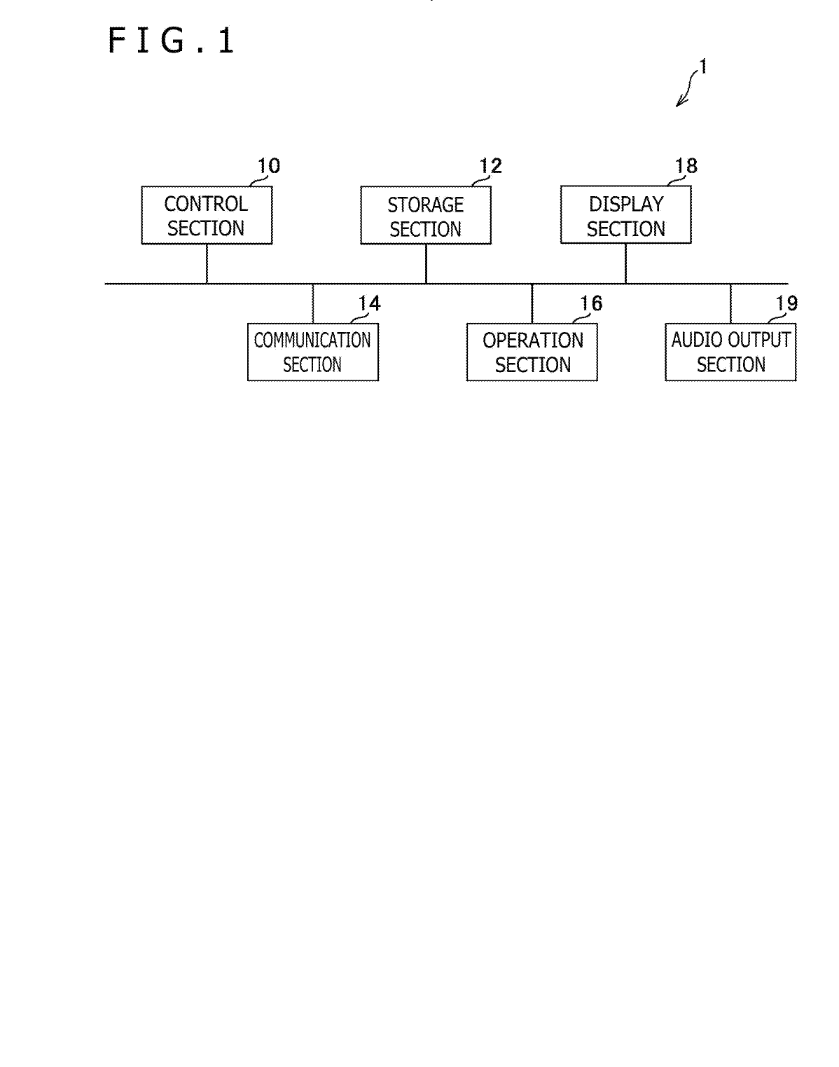

FIG. 1 is a diagram illustrating an example of a hardware configuration of an image processing system 1. The image processing system 1 is, for example, a computer such as a game console (game machine). As illustrated in FIG. 1, the image processing system 1 includes a control section 10, a storage section 12, a communication section 14, an operation section 16, a display section 18, and an audio output section 19.

The control section 10 includes, for example, a program control device such as a central processing unit (CPU) that operates in accordance with a program installed in the image processing system 1. Moreover, the control section 10 also includes a graphics processing unit (GPU) that draws an image in a frame buffer in reference to a graphics command or data supplied from the CPU.

The storage section 12 includes, for example, a main storage device such as a read only memory (ROM) and a random access memory (RAM) and an auxiliary storage device such as a hard disk drive (HDD) and a solid state drive (SSD). The storage section 12 stores therein programs executed by the control section 10, for example. The storage section 12 stores, for example, game programs (game software) in addition to programs for implementing various functions of the image processing system 1 that are to be described later. Moreover, in the storage section 12, an area for a frame buffer in which an image is drawn by the GPU is reserved. Further, the program may be provided by being stored in an appropriate information storage medium such as an optical disk, a magneto-optical disk, and a flash memory.

The communication section 14 is, for example, a communication interface such as an Ethernet (registered trademark) module and a wireless local area network (LAN) module.

The operation section 16 is a user interface such as a keyboard, a mouse, and a controller of a game console, receives operation input made by a user, and outputs a signal indicating contents of the input to the control section 10.

The display section 18 is a display device such as a liquid crystal display and an organic electroluminescence (EL) display and displays various kinds of images in accordance with the instructions given by the control section 10.

The audio output section 19 is, for example, a speaker and outputs audio indicated by audio data generated by the image processing system 1.

Note that the image processing system 1 may, in addition to the devices described above, include an optical disk drive that reads an optical disk such as a digital versatile disc-ROM (DVD-ROM) and a Blu-ray (registered trademark) disc, a universal serial bus (USB) port, and the like.

### 2. Outline of image processing system

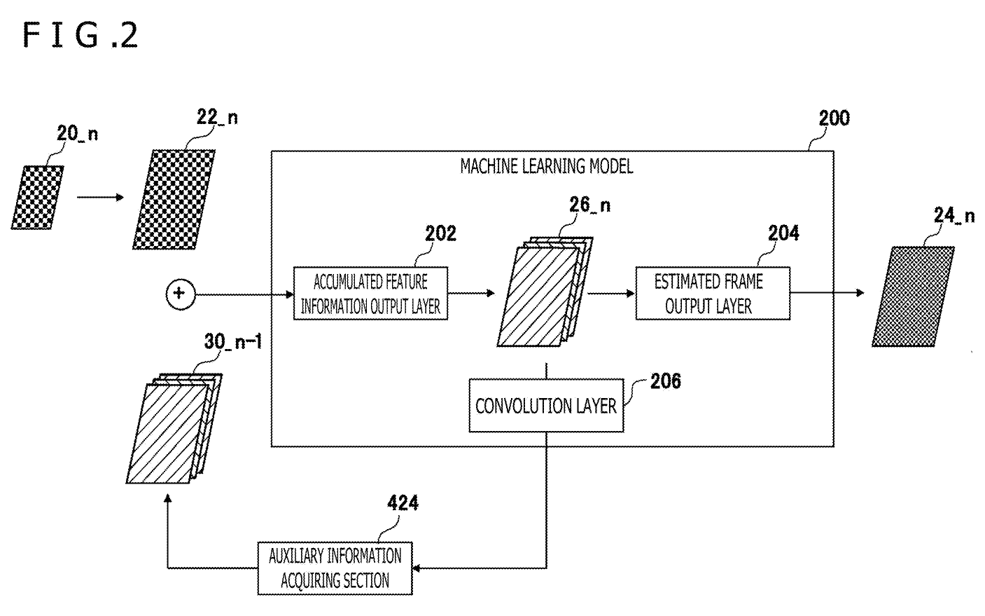

FIG. 2 is a diagram illustrating an outline of the image processing system 1. Here, a case where the image processing system 1 is used for improving the quality of gameplay moving images in a game is illustrated. Gameplay moving images are moving images generated according to the game program executed by the control section 10, user input received by the operation section 16, and the like. Gameplay moving images include a plurality of still images (frames) that are time-series data. The processing executed in the image processing system 1 is mainly as follows.

### (1) Generation of processing target frame

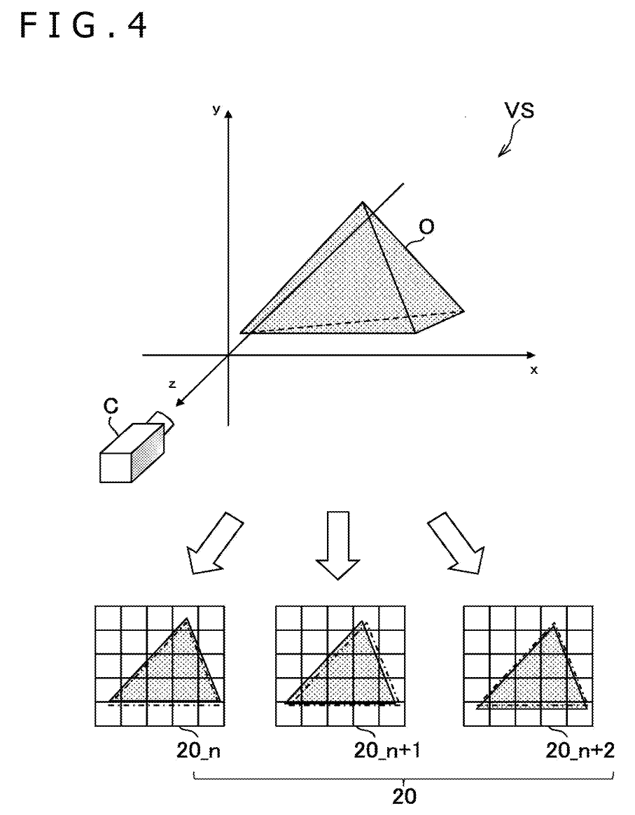

First, the image processing system 1 generates an image (processing target frame) in which one or more game objects are rendered, by executing rendering of three dimensional data indicating the game objects viewed from a predetermined viewpoint. The processing target frame is an image having a predetermined pixel count (initial pixel count) and a predetermined image quality (initial image quality). The processing target frame can be said to be an image indicating, from a predetermined viewpoint, a virtual space VS in which the abovementioned one or more game objects represented by three dimensional data are arranged (see FIG. 4). The processing target frame is generated every predetermined time. The processing target frame has a pixel count of, for example, 1920 × 1080 (1080 p). Each of the generated processing target frames is once stored in the storage section 12 and then subjected to subsequent processing, instead of being directly displayed on the display section 18 without any change. Note that, in the following description, processing targeting an n-th processing target frame 20_nis mainly illustrated, but similar processing is also executed on other processing target frames (that is, n = 2, 3, ..., N).

### (2) Acquisition of input frame

The image processing system 1 acquires a frame (input frame) 22_n that has a pixel count (input pixel count) greater than the initial pixel count, in reference to the acquired processing target frame 20_n. The input pixel count is, for example, 3840 × 2160 (4K). Specifically, the input frame 22_nis generated by enlargement and interpolation processing being executed on the processing target frame 20_n.

Here, note that, while the input frame 22_nhas a pixel count greater than the pixel count of the processing target frame 20_n, its image quality is not necessarily improved to a sufficient level. That is, the image quality of a frame does not simply correspond to the pixel count (resolution). The image quality of a frame may, for example, be evaluated in reference to each of factors including the level of the signal/noise (SN) ratio, the level of reproducibility of a spatial frequency, the level of time stability (the amount of artifact and flickering that occur at the time when a plurality of frames are sequentially displayed), and the like in comparison to a reference frame or in reference to a comprehensive consideration of these factors.

### (3) Acquisition of estimated frame

The image processing system 1 inputs the input frame 22_n to a machine learning model 200, which is a machine learning model, and acquires an estimated frame 24_n. The estimated frame 24_nis an image having a pixel count (estimated pixel count) equal to the input pixel count and an image quality (estimated image quality) equal to or greater than the initial image quality. Here, in addition to the input frame 22_n, (n-1)-th auxiliary information 30_n-1 is input to the machine learning model 200. Details of the (n-1)-th auxiliary information 30_n-1 are described later.

Note that the machine learning model 200 is a model that has learned with use of a plurality of pieces of training data each including a learning input frame having an input pixel count and a learning estimated frame having an estimated pixel count and an estimated image quality.

### (4) Acquisition of accumulated feature information

The machine learning model 200 includes an accumulated feature information output layer 202 that receives, as input, the n-th input frame 22_nand the (n-1)-th auxiliary information 30_n-1 and that outputs n-th accumulated feature information 26_nindicating the features of the first through n-th input frames 22. The image processing system 1 acquires the n-th accumulated feature information 26_n, and the acquired n-th accumulated feature information 26_n is used for generating the n-th auxiliary information 30_n.

Note that the acquired n-th accumulated feature information 26_nis also stored in the storage section 12 and offered for estimation of an estimated frame 24_n+1 that corresponds to the next processing target frame ((n+1)-th processing target frame) 20_n+1.

### (5) Acquisition of auxiliary information

As described above, the (n-1)-th accumulated feature information 26_n-1 is information indicating the features of the first through (n-1)-th input frames 22 (hence, the first through (n-1)-th processing target frames 20). Using the (n-1)-th accumulated feature information 26_n-1, in which pieces of information regarding the past processing target frames 20 are accumulated, for estimation of an n-th estimated frame 24_n increases the amount of information available for estimation, allowing a high quality estimated frame 24_n to be obtained.

However, when any motion or the like of the displayed game object is made between the (n-1)-th processing target frame 20_n-1 and the n-th processing target frame 20_n, if the n-th input frame 22_n and the (n-1)-th accumulated feature information 26_n-1 are input to the machine learning model 200 without any change, such a phenomenon (what is generally called a ghost phenomenon) that an afterimage of the game object that had been displayed in the (n-1)-th processing target frame 20_n-1 is displayed may occur.

In view of this, the image processing system 1 acquires (n-1)-th auxiliary information 30_n-1, based on the information (motion vector, depth buffer, and the like) obtained at the time of rendering, with respect to the (n-1)-th accumulated feature information 26_n-1. The acquired (n-1)-th auxiliary information 30_n-1 is input to the machine learning model 200 together with the n-th input frame 22_n and is offered for estimation of the n-th estimated frame 24_n.

As described above, according to the image processing system 1 of the present embodiment, the estimated frame 24 is estimated with use of auxiliary information 30 in which pieces of past information are accumulated, in addition to the input frame 22. This increases the amount of information available for estimation, allowing a high quality estimated frame 24_nto be obtained.

### 3. Functions implemented by image processing system

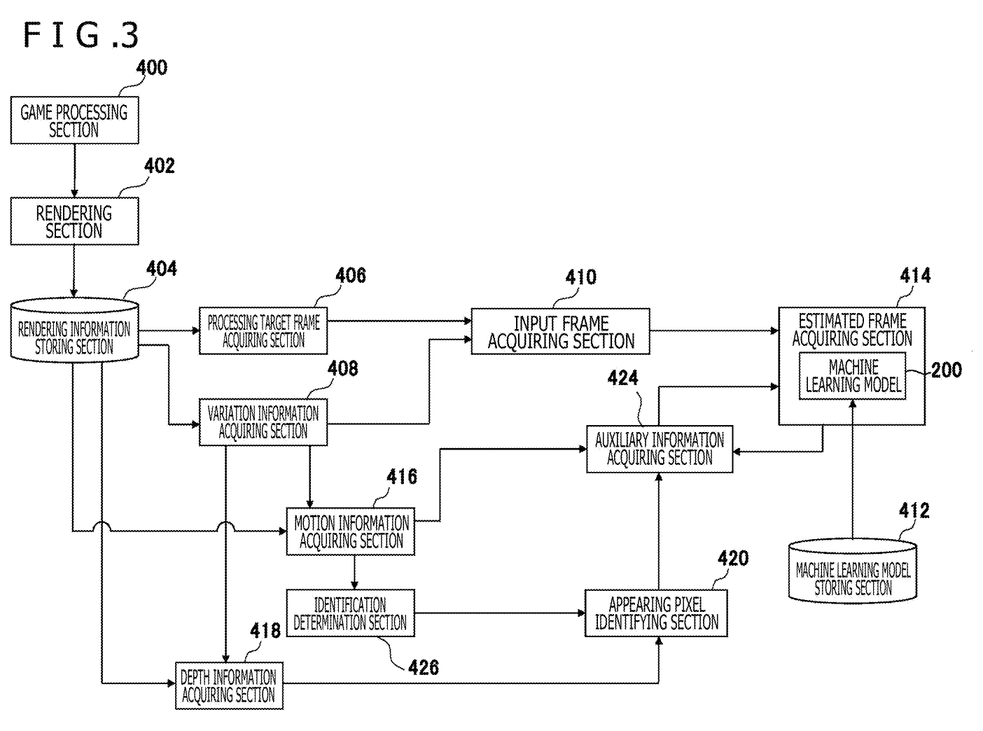

FIG. 3 is a functional block diagram illustrating an example of functions implemented by the image processing system 1. As illustrated in FIG. 3, in the image processing system 1, a game processing section 400, a rendering section 402, a rendering information storing section 404, a processing target frame acquiring section 406, a variation information acquiring section 408, an input frame acquiring section 410, a machine learning model storing section 412, an estimated frame acquiring section 414, a motion information acquiring section 416, a depth information acquiring section 418, an appearing pixel identifying section 420, an auxiliary information acquiring section 424, and an identification determination section 426 are implemented. The game processing section 400, the rendering section 402, the processing target frame acquiring section 406, the variation information acquiring section 408, the input frame acquiring section 410, the estimated frame acquiring section 414, the motion information acquiring section 416, the depth information acquiring section 418, the appearing pixel identifying section 420, the auxiliary information acquiring section 424, and the identification determination section 426 are mainly implemented by the control section 10. The rendering information storing section 404 and the machine learning model storing section 412 are mainly implemented by the storage section 12. Note that the game processing section 400, the rendering section 402, and the rendering information storing section 404 are functions provided by game software.

### Game processing section

The game processing section 400 executes various kinds of processing related to a game. The game processing section 400 executes, for example, processing of arranging a game object O in the virtual space VS, processing of causing the game object O to make an action or move, and processing of changing a viewpoint C for viewing the virtual space VS, according to the game program executed by the control section 10 and user input received by the operation section 16 (see FIG. 4). The game object O includes a primitive such as a polygon indicated by three dimensional data. The three dimensional data includes geometric information indicating the positions of vertices or the like, phase information indicating how to connect the vertices, and attribute information such as color.

### Rendering section

FIG. 4 is a diagram describing processing in the rendering section 402. The rendering section 402 generates first through N-th (N is a natural number equal to or greater than two) processing target frames 20 by executing rendering (drawing process) of three dimensional data indicating one or more game objects O viewed from the predetermined viewpoint C. The processing target frame 20 can also be said to be an image indicating, from the predetermined viewpoint C, the virtual space VS in which one or more game objects O represented by three dimensional data are arranged. The processing target frame 20 has a predetermined initial pixel count. The rendering section 402 executes rendering according to the results of various kinds of processing executed in the game processing section 400. Specifically, the rendering section 402 executes vertex processing (vertex shading) and pixel processing (pixel shading) in reference to three dimensional data indicating the game objects O arranged in the virtual space VS. The vertex processing includes a coordinate conversion process (perspective projection) of converting the coordinate system from a view coordinate system to a screen coordinate system. To a perspective projection matrix (camera matrix) used for the coordinate conversion process, a numerical value related to the variation in the viewpoint C is added, as described later. The rendering section 402 may execute rendering in reference to light source information, depth information (depth buffer), texture information, normal line information, and the like. The rendering section 402 may execute processing of applying such effects as depth of field (DoF) and motion blur, for example, in addition to the processing described above. The processing to be executed by the rendering section 402 may be set as appropriate by the developer of the game software, for example.

Here, the rendering section 402 generates each processing target frame 20 by executing rendering in such a manner that the viewpoint C varies for each processing target frame 20. In this instance, even if the game processing section 400 fixes the viewpoint C to a predetermined position, the rendering section 402 varies the viewpoint C for each processing target frame 20. As a result, as illustrated in FIG. 4, in each of the processing target frames 20_n, 20_n+1, and 20_n+2, the position of the displayed game object O varies. In other words, the rendering section 402 is applying jitter at the time of generating each processing target frame 20. Specifically, the rendering section 402 varies the viewpoint C for each processing target frame 20 by adding a numerical value that corresponds to a size of less than one pixel (unit pixel) and that is different for each processing target frame 20 to the perspective projection matrix.

### Rendering information storing section

The rendering information storing section 404 stores information necessary for rendering processing in the rendering section 402 and information obtained as a result of the rendering processing. For example, the rendering information storing section 404 stores the processing target frame 20.

### Processing target frame acquiring section

The processing target frame acquiring section 406 acquires each of the first through N-th processing target frames 20. Specifically, the processing target frame acquiring section 406 acquires each of the first through N-th processing target frames 20 that are stored in the rendering information storing section 404.

### Variation information acquiring section

The variation information acquiring section 408 acquires pieces of first through N-th variation information which are pieces of information concerning variation in the viewpoint C of each of the first through N-th processing target frames 20 in rendering. The variation information acquiring section 408 acquires the pieces of first through N-th variation information stored in the rendering information storing section 404.

### Input frame acquiring section

The input frame acquiring section 410 acquires each of the first through N-th input frames 22 by generating, in reference to each of the processing target frames 20, input frames 22 that correspond to the respective processing target frames 20 and have an input pixel count equal to or greater than the initial pixel count. In the present embodiment, each input frame 22 has an input pixel count that is greater than the initial pixel count. That is, in the present embodiment, each input frame 22 is an image obtained by enlarging the processing target frame 20 corresponding to the relevant input frame 22.

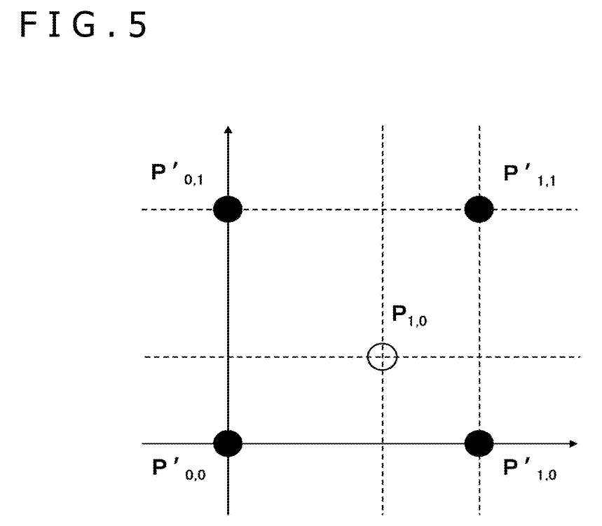

Specifically, the input frame acquiring section 410 obtains, by interpolation, pixel values of positions corresponding to pre-variation pixels in the relevant processing target frame 20, in reference to the variation information and the pixels of each processing target frame 20, and thereby generates each input frame 22. FIG. 5 is a diagram describing processing in the input frame acquiring section 410. FIG. 5 illustrates a case in which an n-th input frame 22_nis acquired. For example, as illustrated in FIG. 5, when the pixel center of a certain pixel in the input frame 22_nwhich is intended to be acquired is (P_{1, 0}), the input frame acquiring section 410 obtains the pixel value of (P_{1, 0}) by bilinear interpolation, according to the coordinates and pixel values of each of the pixel centers (P’_{0, 0}), (P’_{1, 0}), (P’_{0, 1}), and (P’_{1, 1}) of the four pixels closest to (P_{1, 0}) in the n-th processing target frame 20_n. Here, (P’_{1, 0}) is at a position deviated from (P_{1, 0}) by an amount of variation indicated by the variation information. Pixel values of pixels newly generated by the enlargement processing are also similarly obtained. Note that, as the method of interpolation, in addition to bilinear interpolation, various kinds of known techniques including bicubic interpolation, Lanczos interpolation, and the like are available.

When rendering is executed in such a manner that the viewpoint C varies for each processing target frame 20, the amount of time-series information increases. Using the processing target frames 20 obtained in the manner described above (hereinafter referred to as “variation processing target frames”) for estimation makes it possible to obtain an estimated frame 24 with higher image quality.

### Machine learning model storing section

The machine learning model storing section 412 stores the machine learning model 200. Specifically, the machine learning model storing section 412 stores parameters of the machine learning model (the number of convolution layers, the number of nodes used for each convolution layer, the weight of each node, and the like).

The machine learning model 200 is a model that estimates the n-th estimated frame 24_n in reference to the n-th input frame 22_nand the (n-1)-th auxiliary information 30_n-1. The machine learning model 200 is specifically a convolutional neural network (CNN). As the machine learning model 200, for example, known models including ResNet of a multilayer structure having a residual connection mechanism, U-Net of what is called an encoder/decoder type, and the like are available. As the machine learning model 200, the model described in Non Patent Document 1 may be used.

The machine learning model 200 is a model that has learned with use of a plurality of pieces of training data each including a learning input frame having an input pixel count and a learning estimated frame having an estimated pixel count. The machine learning model 200 includes the accumulated feature information output layer 202, the estimated frame output layer 204, and a convolution layer 206 (see FIG. 2).

The accumulated feature information output layer 202 receives, as input, the n-th input frame 22_nand the (n-1)-th auxiliary information 30_n-1, and outputs the n-th accumulated feature information 26_n indicating the features of the first through n-th input frames 22_n. The accumulated feature information output layer 202 may, for example, include one or more convolution layers. The accumulated feature information is image information (information in bitmap format) having a pixel count equal to the input pixel count. The n-th accumulated feature information 26_ncan also be said to be a feature map indicating the features of the first through n-th input frames 22.

Note that the accumulated feature information output layer 202 receives, as input, the first input frame 22_1 and given auxiliary information and outputs the first accumulated feature information 26_1. In the case of n = 1, since there has been no accumulated feature information 26, given auxiliary information prepared in advance is input to the accumulated feature information output layer 202, together with the first input frame 22_1.

The estimated frame output layer 204 receives, as input, the n-th accumulated feature information 26_n, and outputs the n-th estimated frame 24_n. The estimated frame output layer 204 may, similarly to the accumulated feature information output layer 202, include one or more convolution layers, for example. Alternatively, the estimated frame output layer 204 may include one or more transposed convolution layers (deconvolution layers).

The convolution layer 206 is a layer that reduces the number of channels of the accumulated feature information 26 while maintaining the pixel count thereof. The convolution layer 206 can reduce the dimensions of the accumulated feature information 26, thus achieving lower computation costs. The convolution layer 206 is, for example, a convolution layer with a kernel count of 1 × 1, but is not limited thereto.

### Estimated frame acquiring section

The estimated frame acquiring section 414 acquires an estimated frame 24 having an estimated pixel count greater than the initial pixel count and equal to or greater than the input pixel count, in reference to the input frame 22, the auxiliary information 30, and the machine learning model 200. In the present embodiment, the estimated frame 24 has an estimated pixel count that is equal to the input pixel count.

### Motion information acquiring section

The motion information acquiring section 416 acquires n-th motion information which is information indicating the amount and direction of motion from the past frame to the n-th input frame 22_n that is the current frame. The n-th motion information is specifically image information indicating the amount and direction of motion of each pixel made between the (n-1)-th input frame 22_n-1 and the n-th input frame 22_n. Motion information is also called a motion vector. Motion information is information having a pixel count equal to the input pixel count. The motion information acquiring section 416 specifically acquires original motion information having a pixel count equal to the initial pixel count, and executes enlargement and interpolation processing on the original motion information to acquire motion information having pixels equal in number to the input pixel count.

### Depth information acquiring section

The depth information acquiring section 418 acquires (n-1)-th depth information indicating the depth of each pixel of the (n-1)-th input frame 22_n-1 and n-th depth information indicating the depth of each pixel of the n-th input frame 22_n. Depth information is also called a depth buffer or a Z buffer. Depth information is information having a pixel count equal to the input pixel count. Specifically, the depth information acquiring section 418 acquires original depth information having a pixel count equal to the initial pixel count, and executes enlargement and interpolation processing on the original depth information to acquire depth information having a pixel count equal to the input pixel count.

### Appearing pixel identifying section

The appearing pixel identifying section 420 identifies a pixel which had been hidden in the past frame but is visualized in the current frame, as an appearing pixel. Specifically, the appearing pixel identifying section 420 identifies an appearing pixel that is a pixel among the pixels of the n-th input frame 22_n and that is in an area in which a whole or part of an object that is not displayed in the (n-1)-th input frame 22_n-1 is displayed, in reference to the (n-1)-th depth information and the n-th depth information.

The appearing pixel identifying section 420 preferably identifies an appearing pixel in reference to a difference between the (n-1)-th depth information in each pixel of the (n-1)-th input frame 22_n-1 and the n-th depth information in each pixel of the n-th input frame 22_n. Note that the appearing pixel identifying section 420 may identify the appearing pixel in reference to an (n-1)-th perspective projection matrix related to the (n-1)-th input frame 22_n-1 and an n-th perspective projection matrix related to the n-th input frame 22_n.

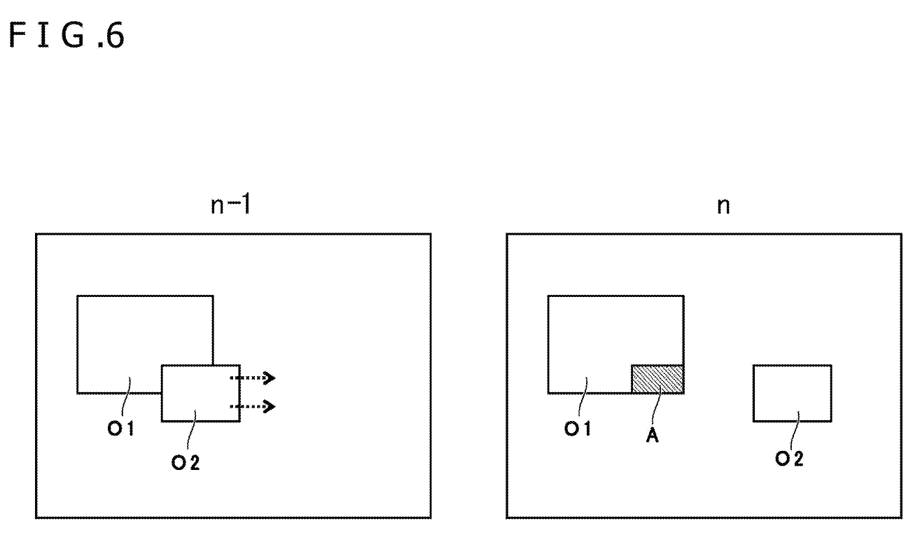

FIG. 6 illustrates a state in which part of an object O1 is not displayed due to an object O2 being arranged in front of the object O1 in the (n-1)-th input frame 22_n-1. Moreover, FIG. 6 illustrates a state in which an area of the object O1 that had been hidden has appeared due to the object O2 moving and an appearing pixel area A including a plurality of appearing pixels is identified in the n-th input frame 22_n.

### Auxiliary information acquiring section

The auxiliary information acquiring section 424 causes motion compensation to be applied to the (n-1)-th accumulated feature information 26_n-1 in reference to the (n-1)-th motion information and acquires the (n-1)-th auxiliary information 30_n-1. Motion compensation refers to processing of, for example, moving a pixel of the (n-1)-th accumulated feature information 26_nfrom a position x to a position x’, in a case where a pixel that had been present at the position x in the (n-1)-th input frame 22_n-1 moves to the position x’ in the n-th input frame 22_n. More specifically, the auxiliary information acquiring section 424 acquires the (n-1)-th auxiliary information 30_n-1 by setting the pixel value of each of the one or more pixels of the (n-1)-th accumulated feature information 26_n-1 for the pixel at a position to which movement has been made in accordance with the amount and direction of motion of the pixel, in reference to the (n-1)-th motion information.

In a case where any motion of the game object O has been made between the n-th input frame 22_n and the (n-1)-th input frame 22_n-1, if the n-th input frame 22_nand the (n-1)-th accumulated feature information 26_n-1 are input to the machine learning model 200 without any change at the time of acquiring the n-th estimated frame 24_n, a ghost phenomenon in which an afterimage of the game object O that had been displayed in the n-th input frame 22_nis displayed may occur in the n-th estimated frame 24_nthat is output.

In view of this, in the image processing system 1, as described above, the auxiliary information 30 is acquired by causing motion compensation to be applied to the accumulated feature information in reference to the motion information, and is input to the machine learning model 200 when the estimated frame 24 is to be acquired. This can restrain the abovementioned ghost phenomenon from occurring.

Moreover, the auxiliary information acquiring section 424 acquires the (n-1)-th auxiliary information 30_n-1 by replacing the pixel value of the appearing pixel in the (n-1)-th accumulated feature information 26_n-1 with a predetermined value. Specifically, the auxiliary information acquiring section 424 acquires the (n-1)-th auxiliary information 30_n-1 by replacing the pixel value of each appearing pixel in the (n-1)-th accumulated feature information 26_n-1 with a predetermined value. The predetermined value is preferably a fixed value such as zero (black), for example.

In a case where a whole or part of the game object O that had not been displayed in the (n-1)-th input frame 22_n-1 is displayed in the n-th input frame 22_n, if the n-th input frame 22_n and the (n-1)-th accumulated feature information 26_n-1 are input to the machine learning model 200 without any change at the time of acquiring the n-th estimated frame 24_n, a ghost phenomenon may occur in the n-th estimated frame 24_n that is output.

In view of this, in the image processing system 1, as described above, an appearing pixel that is among the pixels of the n-th input frame 22_n and in which a whole or part of the game object O that had not been displayed in the (n-1)-th input frame 22_n-1 is displayed is identified, and the pixel value of the appearing pixel in the (n-1)-th accumulated feature information 26_n-1 is replaced with a predetermined value, to acquire the (n-1)-th auxiliary information 30_n-1. This can restrain the abovementioned ghost phenomenon from occurring.

In the following description, the processing of identifying an appearing pixel in the n-th input frame 22_n and replacing the pixel value of the appearing pixel in the (n-1)-th accumulated feature information 26_n-1 with a predetermined value is called “generation of a disocclusion mask.” Note that the “appearing pixel in the accumulated feature information” is a pixel that is at the same position as the appearing pixel identified in the input frame.

### Identification determination section

Here, in the rendering processing, a slight change in the outline or small portion of an object that is still or substantially still, which is caused by the influence of the jitter described above, may result in unnecessary generation of a disocclusion mask. This could lead to a failure in the input of information which should be used as the information regarding the main body and past frames to the machine learning model 200, and hence, a decline in the estimation accuracy in the machine learning model 200.

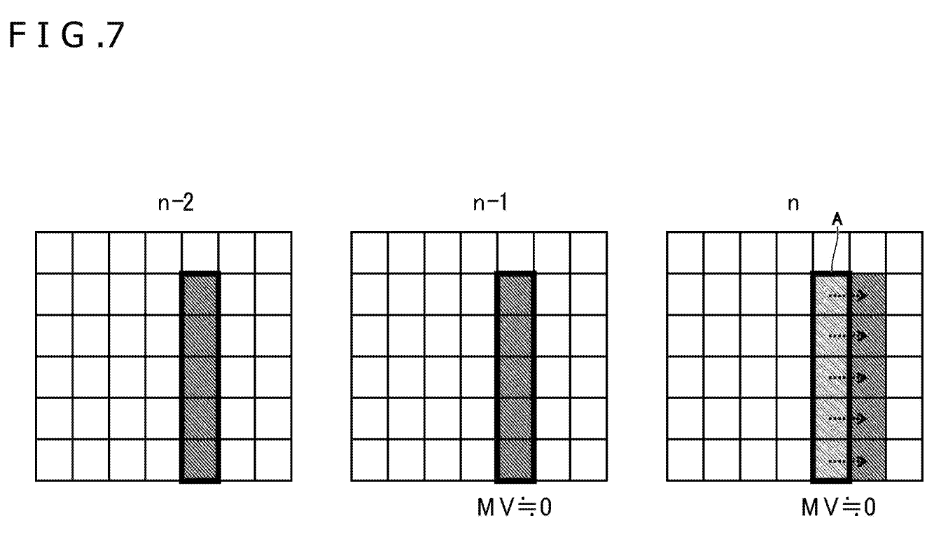

FIG. 7 illustrates an example in which an unnecessary disocclusion mask may be generated due to the influence of jitter despite the object being substantially still (the amount of motion in the pixel indicating the object being substantially zero) (an example in which the pixel value in the appearing pixel area A may be replaced with a predetermined value).

In view of this, in the present embodiment, the identification determination section 426 determines whether or not a predetermined condition is satisfied, and suppresses generation of a disocclusion mask when the predetermined condition is satisfied. Specifically, the appearing pixel identifying section 420 does not identify, as the appearing pixel, a pixel satisfying the predetermined condition. As a result, in acquiring the (n-1)-th auxiliary information 30_n-1, the pixel value of each pixel in the (n-1)-th accumulated feature information 26_n-1 is not replaced with a predetermined value, and the pixel value of each pixel is used without any change.

A case where the predetermined condition is satisfied is, for example, a case where the amount of motion (the magnitude of the motion vector) in a predetermined pixel in the (n-1)-th input frame 22_n-1 is less than one pixel (less than a unit pixel width that is a first threshold) and the amount of motion (the magnitude of the motion vector) in the predetermined pixel in the n-th input frame 22_n is less than one pixel (less than a unit pixel width that is a second threshold). As a result, unnecessary generation of a disocclusion mask caused by slight position variation that occurs due to the influence of jitter is suppressed, thereby restraining the estimation accuracy in the machine learning model 200 from declining.

Note that the predetermined condition that requires the amount of motion in a predetermined pixel to be less than one pixel is an example and is not limited thereto. For example, the predetermined condition may require the amount of motion in a predetermined pixel to be less than 0.5 pixel or two pixels. Moreover, the first threshold related to the n-th input frame 22_n and the second threshold related to the (n-1)-th input frame 22_n-1 may be the same as or different from each other. Further, the first threshold and the second threshold may be values set according to numerical values associated with the variation in the viewpoint C and added to the perspective projection matrix in jitter rendering. In a case of adding a numerical value corresponding to a size of less than one pixel (unit pixel) to the perspective projection matrix, the first threshold and the second threshold are preferably one pixel as in the present embodiment.

Further, in the present embodiment, an example of suppressing unnecessary generation of a disocclusion mask caused by the influence of jitter has been described, but unnecessary generation of a disocclusion mask caused by such influence as slight vibration of the viewpoint C or slight position variation in the viewpoint C that occurs due to factors other than jitter may be suppressed.

### 4. Processing executed in image processing system

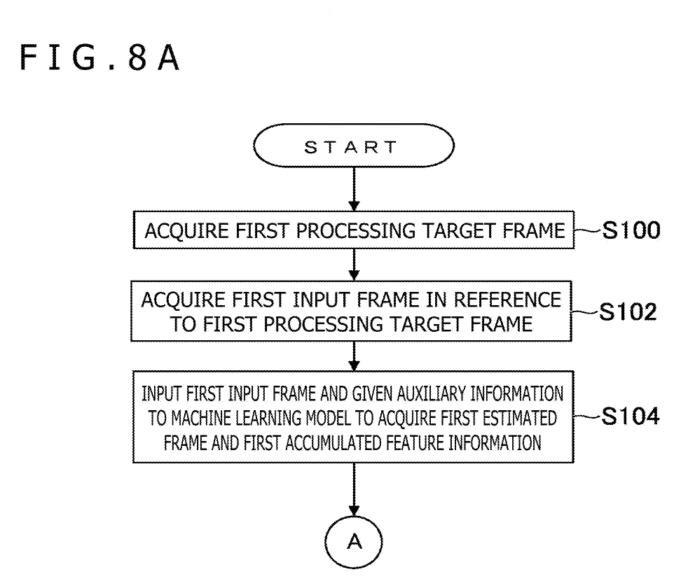

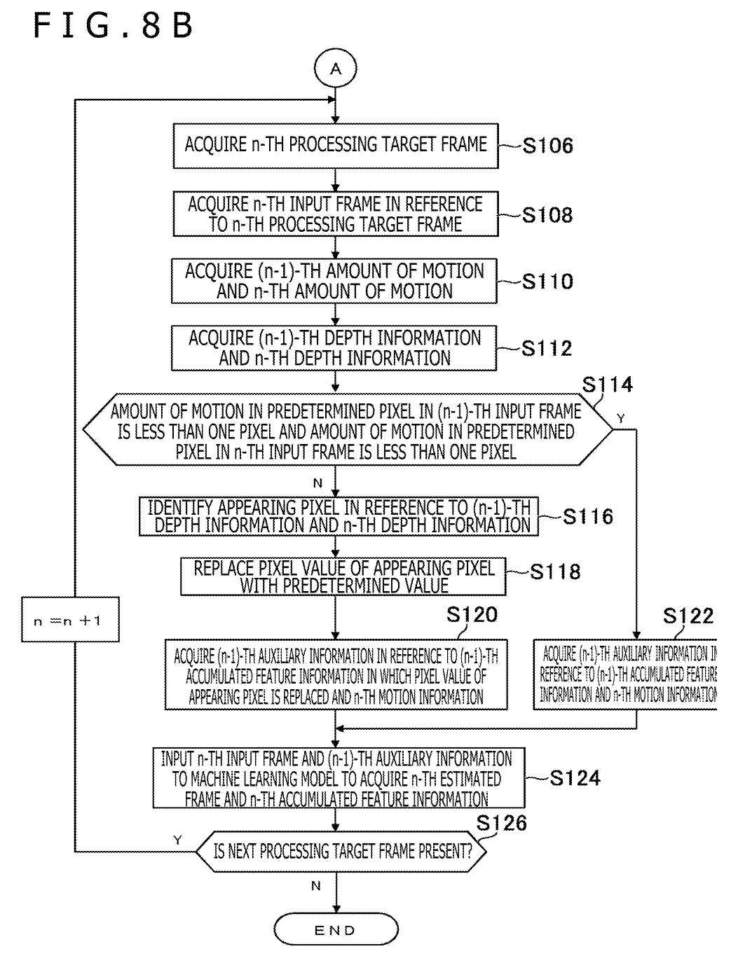

FIGS. 8A and 8B are each a flowchart illustrating an example of a flow of processing executed in the image processing system 1. The processing illustrated in FIGS. 8A and 8B is executed by the control section 10 operating in accordance with a program stored in the storage section 12.

(1) Processing when n = 1

First, the control section 10 acquires a first processing target frame 20_1 (S100). The control section 10 then acquires a first input frame 22_1 in reference to the first processing target frame 20_1 (S102). Next, the control section 10 inputs the input frame 22_1 and given auxiliary information to the machine learning model 200 to acquire a first estimated frame 24_1 and first accumulated feature information 26_1 (S104).

(2) Processing when n ≥ 2

The control section 10 acquires an n-th processing target frame 20_n (S106). The control section 10 then acquires an n-th input frame 22_n in reference to the n-th processing target frame 20_n (S108).

Next, the control section 10 acquires (n-1)-th motion information and n-th motion information (S110). Subsequently, the control section 10 acquires (n-1)-th depth information and n-th depth information (S112).

Then, the control section 10 determines whether or not the amount of motion in a predetermined pixel in an (n-1)-th input frame 22_n-1 is less than one pixel and the amount of motion in the predetermined pixel in the n-th input frame 22_n is less than one pixel (S114).

When these conditions are not satisfied (N in S114), the control section 10 generates a disocclusion mask. Specifically, the control section 10 identifies an appearing pixel in reference to the (n-1)-th depth information and the n-th depth information (S116), and replaces the pixel value of the appearing pixel in (n-1)-th accumulated feature information 26_n-1 with a predetermined value (S118). Thereafter, the control section 10 acquires (n-1)-th auxiliary information 30_n-1 in reference to the (n-1)-th accumulated feature information 26_n-1 in which the pixel value of the appearing pixel is replaced with a predetermined value and the n-th motion information (S120).

On the other hand, when the conditions in S114 are satisfied (Y in S114), the control section 10 does not generate a disocclusion mask. That is, the control section 10 does not identify the appearing pixel and does not replace the pixel value of a pixel in the (n-1)-th accumulated feature information 26_n-1. Thereafter, the control section 10 acquires the (n-1)-th auxiliary information 30_n-1 in reference to the (n-1)-th accumulated feature information 26_n-1 and the n-th motion information (S122).

Then, the control section 10 inputs the n-th input frame 22_n and the (n-1)-th auxiliary information 30_n-1 to the machine learning model 200 to acquire the n-th estimated frame 24_n and the n-th accumulated feature information 26_n (S124).

Next, the control section 10 determines whether or not the next frame is present (S126). In the case of determining that the next frame is present (Y in S126), the control section 10 increments the value to n = n + 1 and repeats the processing in S106 through S124. In the case of determining that the next frame is not present (N in S126), the control section 10 ends the processing.

### 5. Summary

The image processing system 1 according to the present embodiment described above suppresses unnecessary generation of a disocclusion mask, and can thus effectively use information regarding past frames. As a result, a sufficient amount of information can be used for estimation, allowing a high quality estimated frame 24_n to be obtained.

Note that the present invention is not limited to the embodiment described above. For example, in the present embodiment, a case in which the input pixel count is greater than the initial pixel count but is equal to the estimated pixel count has been illustrated, but the input pixel count and the initial pixel count may be equal to each other, and the estimated pixel count may be greater than the input pixel count. That is, the input frame 22 may not necessarily be obtained by enlargement of the processing target frame 20.

Further, in the present embodiment, an example in which the auxiliary information 30_n-1 is generated in reference to the (n-1)-th accumulated feature information 26_n-1 indicating the features of the first through (n-1)-th input frames 22 has been described, but the present invention is not limited to such an example, and the auxiliary information 30_n-1 is preferably generated in reference to at least feature information indicating the features of the (n-1)-th input frame 22_n-1.

What is claimed is:

1. An image processing system comprising:
at least one processor; and
computer-readable media storing instructions which, when executed by the at least one processor, cause the image processing system to perform operations comprising:
acquiring first through n-th input frames by rendering three dimensional data indicating one or more objects and in which a virtual space is viewed from a predetermined viewpoint; and
acquiring an n-th estimated frame that is to be output from a machine learning model as a result of an n-th input frame and (n-1)-th auxiliary information being input to the machine learning model, the (n-1)-th auxiliary information being based on (n-1)-th feature information indicating a feature of an (n-1)-th input frame, wherein acquiring the n-th estimated frame comprises:
acquiring (n-1)-th depth information indicating a depth of each pixel of the (n-1)-th input frame and n-th depth information indicating a depth of each pixel of the n-th input frame;
identifying, based on the (n-1)-th depth information and the n-th depth information, an appearing pixel that is among pixels of the n-th input frame and is in an area in which a whole or part of an object of the one or more objects not displayed in the (n-1)-th input frame;
acquiring the (n-1)-th auxiliary information by replacing a pixel value of the appearing pixel in the (n-1)-th feature information with a predetermined value;
acquiring an (n-1)-th amount of motion indicating magnitude of motion in each pixel of the (n-1)-th input frame and an n-th amount of motion indicating magnitude of motion in each pixel of the n-th input frame; and
when the (n-1)-th amount of motion in a predetermined pixel in the (n-1)-th input frame is less than a first threshold and the n-th amount of motion in the predetermined pixel in the n-th input frame is less than a second threshold, input the n-th input frame and (n-1)-th auxiliary information to the machine learning model to acquire the n-th estimate frame.

2. The image processing system according to claim 1, wherein at least one of the first threshold and the second threshold is a unit pixel width.

3. The image processing system according to claim 1, wherein the first threshold and the second threshold are each a unit pixel width.

4. The image processing system according to claim 1, wherein the operations further comprise:
acquiring first through N-th processing target frames that are frames indicating, from a predetermined viewpoint, a virtual space in which one or more objects represented by three dimensional data are arranged and that are obtained by rendering being executed in such a manner that the viewpoint varies for each frame,
acquiring variation information that is information regarding variation in the viewpoint for each of the processing target frames in the rendering, and
obtaining, by interpolation, a pixel value of a position corresponding to each pre-variation pixel in the relevant processing target frame, in reference to the variation information and each pixel of the processing target frames, to generate each of the input frames, wherein the first threshold and the second threshold are each a value set according to a numerical value that is associated with variation in the viewpoint and that is added to a perspective projection matrix in the rendering.

5. The image processing system according to claim 1, wherein n comprises a natural number greater than or equal to 2.

6. An image processing method comprising:
acquiring first through n-th input frames by rendering three dimensional data that indicates one or more objects and in which a virtual space is viewed from a predetermined viewpoint;
acquiring an n-th estimated frame that is to be output from a machine learning model as a result of an n-th input frame and (n-1)-th auxiliary information being input to the machine learning model, the (n-1)-th auxiliary information being based on (n-1)-th feature information indicating a feature of an (n-1)-th input frame;
acquiring (n-1)-th depth information indicating a depth of each pixel of the (n-1)-th input frame and n-th depth information indicating a depth of each pixel of the n-th input frame;
identifying, based on the (n-1)-th depth information and the n-th depth information, an appearing pixel that is among pixels of the n-th input frame and is in an area in which a whole or part of an object of the one or more objects not displayed in the (n-1)-th input frame;
acquiring the (n-1)-th auxiliary information by replacing a pixel value of the appearing pixel in the (n-1)-th feature information with a predetermined value;
acquiring an (n-1)-th amount of motion indicating magnitude of motion in each pixel of the (n-1)-th input frame and an n-th amount of motion indicating magnitude of motion in each pixel of the n-th input frame; and
when the (n-1)-th amount of motion in a predetermined pixel in the (n-1)-th input frame is less than a first threshold and the n-th amount of motion in the predetermined pixel in the n-th input frame is less than a second threshold, input the n-th input frame and (n-1)-th auxiliary information to the machine learning model to acquire the n-th estimate frame.

7. The image processing method of claim 6, wherein n comprises a natural number greater than or equal to 2.

8. A non-transitory computer-readable information storage medium for storing a program which, when executed by one or more processors, causes a system to perform operations comprising:
acquiring first through N-th input frames by rendering three dimensional data that indicates one or more objects and in which a virtual space is viewed from a predetermined viewpoint;
acquiring an n-th estimated frame that is to be output from a machine learning model as a result of an n-th input frame and (n-1)-th auxiliary information being input to the machine learning model, the (n-1)-th auxiliary information being based on (n-1)-th feature information indicating a feature of an (n-1)-th input frame;
acquiring (n-1)-th depth information indicating a depth of each pixel of the (n-1)-th input frame and n-th depth information indicating a depth of each pixel of the n-th input frame;
identifying, based on the (n-1)-th depth information and the n-th depth information, an appearing pixel that is among pixels of the n-th input frame and is in an area in which a whole or part of an object of the one or more objects not displayed in the (n-1)-th input frame;
acquiring the (n-1)-th auxiliary information by replacing a pixel value of the appearing pixel in the (n-1)-th feature information with a predetermined value;
acquiring an (n-1)-th amount of motion indicating magnitude of motion in each pixel of the (n-1)-th input frame and an n-th amount of motion indicating magnitude of motion in each pixel of the n-th input frame; and
when the (n-1)-th amount of motion in a predetermined pixel in the (n-1)-th input frame is less than a first threshold and the n-th amount of motion in the predetermined pixel in the n-th input frame is less than a second threshold, input the n-th input frame and (n-1)-th auxiliary information to the machine learning model to acquire the n-th estimate frame.

9. The non-transitory computer-readable information storage medium of claim 8, wherein n comprises a natural number greater than or equal to 2.
